(19) United States
(12) Patent Application Publication
(10) Pub. No.: US 2023/0003695 A1
(43) Pub. Date: Jan. 5, 2023

(54) COMPRESSION USING PEAK DETECTION FOR ACOUSTIC FULL MATRIX CAPTURE (FMC)

(71) Applicant: Olympus NDT Canada Inc., Quebec (CA)

(72) Inventors: Nicolas Badeau, Quebec (CA); Guillaume Painchaud-April, L'Ancienne-Lorette (CA)

(21) Appl. No.: 17/809,926

(22) Filed: Jun. 30, 2022

Related U.S. Application Data
(60) Provisional application No. 63/216,815, filed on Jun. 30, 2021.

(51) Int. Cl. G01N 29/44; G01N 29/06; G01N 29/24; G01N 29/04

(52) U.S. Cl. CPC G01N 29/4472; G01N 29/0654; G01N 29/4454; G01N 29/2456; G01N 29/041; G01N 29/043; G01N 2291/044

(57) ABSTRACT

A compression technique can be used for processing or storage of acquired acoustic inspection data. For example, data indicative of peak values of an A-scan time-series can be stored to provide a compressed representation of such time-series data. A representation of the original A-scan data can be reconstructed, such as using the data indicative of the peak values, and a digital filter. Such an approach can dramatically reduce a volume of data associated an acoustic acquisition, such as a Full Matrix Capture (FMC) acquisition to be used for Total Focusing Method (TFM) beamforming and related imaging.

### CLAIM OF PRIORITY

This patent application claims the benefit of priority of Badeau et al., U.S. Provisional Patent Application Ser. No. 63/216,815, titled “COMPRESSION USING PEAK DETECTION FOR ACOUSTIC FULL MATRIX CAPTURE (FMC),” filed on Jun. 30, 2021 (Attorney Docket No. 6409.206PRV), which is hereby incorporated by reference herein in its entirety.

### FIELD OF THE DISCLOSURE

This document pertains generally, but not by way of limitation, to non-destructive evaluation, and more particularly, to apparatus and techniques for providing acoustic inspection, such as using a full matrix capture (FMC) acquisition approach where acquired A-scan data is compressed.

### BACKGROUND

Various inspection techniques can be used to image or otherwise analyze structures without damaging such structures. For example, one or more of x-ray inspection, eddy current inspection, or acoustic (e.g., ultrasonic) inspection can be used to obtain data for imaging of features on or within a test specimen. For example, acoustic imaging can be performed using an array of ultrasound transducer elements, such as to image a region of interest within a test specimen. Different imaging modes can be used to present received acoustic signals that have been scattered or reflected by structures on or within the test specimen.

### SUMMARY

Acoustic testing, such as ultrasound-based inspection, can include focusing or beam-forming techniques to aid in construction of data plots or images representing a region of interest within the test specimen. Use of an array of ultrasound transducer elements can include use of a phased-array beamforming approach and can be referred to as Phased Array Ultrasound Testing (PAUT). For example, a delay-and-sum beamforming technique can be used such as including coherently summing time-domain representations of received acoustic signals from respective transducer elements or apertures. In another approach, a Total Focusing Method (TFM) technique can be used where one or more elements in an array (or apertures defined by such elements) are used to transmit an acoustic pulse and other elements are used to receive scattered or reflected acoustic energy, and a matrix is constructed of time-series (e.g., A-Scan) representations corresponding to a sequence of transmit-receive cycles in which the transmissions are occurring from different elements (or corresponding apertures) in the array. Such an approach where A-scan data is obtained for each element in an array (or each defined aperture) can be referred to as a “full matrix capture” (FMC) technique.

Capturing time-series A-scan data either for PAUT or TFM beamforming applications can involve generating considerable volumes of data. For example, digitization of A-scan time-series data can be performed locally by a test instrument having an analog-front-end and analog-to-digital converter physically cabled to a transducer probe assembly. A corresponding digitized amplitude resolution (e.g., 8-bit or 12-bit resolution) and time resolution (e.g., corresponding to a sample rate in excess of tens or hundreds of megasamples per second) can result in gigabits of time-series data for each received A-scan record for later processing, particularly if such A-scan records are stored as full-bandwidth and full-resolution analytic representations. Accordingly, the present inventors have recognized, among other things, that a compression technique can be used for processing or storage of acquired acoustic inspection data. For example, data indicative of peak values of an A-scan time-series can be stored to provide a compressed representation of such time-series data. A representation of the original A-scan data can be reconstructed, such as using the data indicative of the peak values, and a digital filter. Such an approach can dramatically reduce a volume of data associated an acoustic acquisition, such as a Full Matrix Capture (FMC) acquisition to be used for Total Focusing Method (TFM) beamforming and related imaging.

In an example, a machine-implemented method for processing compressed acoustic inspection data can include receiving digital representations of peak locations in acquired acoustic echo data corresponding to respective received acoustic echo signals, the respective received acoustic echo signals corresponding to transducer apertures of a multi-element electroacoustic transducer array used for an acoustic inspection operation, reconstructing time-series representations of respective received acoustic echo signals including up-sampling the digital representations of the peak locations and applying a time-domain interpolation filter, and processing the time-series representations of the respective received acoustic echo signals to generate a visual representation of a result of the acoustic inspection operation. Generally, the digital representations of the peak locations comprise a lesser volume of data than the reconstructed time-series representations.

In an example, a system for processing compressed acoustic inspection data can include a first processing facility comprising at least one first processor circuit and at least one first memory circuit, along with a first communication circuit communicatively coupled with the first processing facility. The at least one first memory circuit comprises instructions that, when executed by the at least one first processor circuit, cause the system to receive, using the first communication circuit, digital representations of peak locations in acquired acoustic echo data corresponding to respective received acoustic echo signals, the respective received acoustic echo signals corresponding to transducer apertures of a multi-element electroacoustic transducer array used for acoustic inspection operation, reconstruct time-series representations of respective received acoustic echo signals including up-sampling the digital representations of the peak locations and applying a time-domain interpolation filter, an process the time-series representations of the respective received acoustic echo signals to generate a visual representation of a result of the acoustic inspection operation.

In an example, the system can include a second processing facility comprising at least one second processor circuit and at least one second memory circuit, along with a second communication circuit communicatively coupled with the second processing facility and communicatively coupled with first communication circuit. Generally, the at least one second memory circuit comprises instructions that, when executed by the at least one second processor circuit, cause the system to digitize acoustic echo data acquired by the multi-element electroacoustic transducer array using an analog front-end circuit coupled with the multi-element electroacoustic transducer array, generate digital representations of peak locations in acquired acoustic echo data corresponding to respective received acoustic echo signals, and transmit, using the second communication circuit, the digital representations of peak locations to the first communication circuit.

In an example, a system for processing compressed acoustic inspection data can include a means for digitizing acoustic echo data acquired by a multi-element electroacoustic transducer array, a means for generating digital representations of peak locations in acquired acoustic echo data corresponding to respective received acoustic echo signals, the respective received acoustic echo signals corresponding to transducer apertures of a multi-element electroacoustic transducer array used for an acoustic inspection operation, a means for reconstructing time-series representations of respective received acoustic echo signals including up-sampling the digital representations of the peak locations and applying a time-domain interpolation filter, and a means for processing the time-series representations of the respective received acoustic echo signals to generate a visual representation of a result of the acoustic inspection operation.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising an acoustic inspection system, such as can be used to perform at least a portion one or more techniques as shown and described herein.

FIG. 2A shows an illustrative example of an acquired acoustic echo signal (e.g., representative of an acquired A-scan echo signal).

FIG. 2B shows an illustrative example of identification of positive-going peak locations in the acquired acoustic echo signal of FIG. 2A.

FIG. 2C shows an illustrative example of identification of positive-going peak locations and negative-going peak locations in the acquired acoustic echo signal of FIG. 2A.

FIG. 3A shows a comparison between the originally acquired acoustic echo signal (e.g., the A-scan) of FIG. 2A, identified positive-going peak locations and negative-going peak locations, and a reconstructed time-series representation generated using a linear interpolation filter.

FIG. 3B shows the filter coefficient amplitudes versus filter tap (corresponding to a time delay of “n” samples) for the linear interpolation filter used to generate the reconstruction shown in FIG. 3A.

FIG. 4A shows a comparison between the originally acquired acoustic echo signal (e.g., the A-scan) of FIG. 2A, identified positive-going peak locations, and a reconstructed time-series representation generated using a wavelet (e.g., Gabor) filter.

FIG. 4B shows the filter coefficient amplitudes versus filter tap (corresponding to a time delay of “n” samples) for the wavelet interpolation filter used to generate the reconstruction shown in FIG. 4A.

FIG. 5A shows an illustrative example of imaging generated using a Total Focusing Method (TFM) summation, performed on Full Matrix Capture (FMC) data comprising a matrix of A-scan time-series representations that have not been compressed or reconstructed, where elements in the FMC matrix define respective transmit-receive aperture pairs used for acquisition.

FIG. 5B shows an illustrative example of imaging generated using a Total Focusing Method (TFM) summation for beamforming, performed on Full Matrix Capture (FMC) data comprising a matrix of reconstructed time-series representations generated using a linear interpolation filter, similar to the example of FIG. 3B, where the reconstruction is performed by applying the interpolation filter to data indicative of positive-going and negative-going peak locations in each respective time series.

FIG. 5C shows an illustrative example of imaging generated using a Total Focusing Method (TFM) summation for beamforming, performed on Full Matrix Capture (FMC) data comprising a matrix of reconstructed time-series representations generated using a wavelet-based interpolation filter, similar to the example of FIG. 4B, where the reconstruction is performed by applying the interpolation filter to data indicative of positive-going peak locations in each respective time series.

FIG. 6A shows a technique, such as a machine-implemented method, that can be used for performing beamforming and related imaging using a Total Focusing Method (TFM), including generation of an analytic signal representation.

FIG. 6B shows a technique, such as a machine-implemented method, that can be used for performing beamforming and related imaging using a Total Focusing Method (TFM), where related interpolation filters can be used for signal reconstruction and generation of an analytic signal representation contemporaneously.

FIG. 7A shows the filter coefficient amplitudes versus filter tap (corresponding to a time delay of “n” samples) for two related linear interpolation filters that can be used in relation to the technique of FIG. 6B to perform reconstruction contemporaneously with generation of an analytic signal representation for beamforming and imaging.

FIG. 7B shows the filter coefficient amplitudes versus filter tap (corresponding to a time delay of “n” samples) for two related wavelet interpolation filters that can be used in relation to the technique of FIG. 6B to perform reconstruction contemporaneously with generation of an analytic signal representation for beamforming and imaging.

FIG. 8 illustrates generally a technique, such as a method, that can be used for performing processing of time-series representations, such as to perform one or more of compression or decompression of digital representations of acoustic imaging data.

FIG. 9 illustrates a block diagram of an example comprising a machine upon which any one or more of the techniques (e.g., methodologies) discussed herein may be performed.

### DETAILED DESCRIPTION

As mentioned above, apparatus and techniques are described herein that can be used to enhance acoustic inspection productivity. For example, a representation of the originally-acquired acoustic echo data (e.g., A-scan data) can be reconstructed from a compressed representation including data indicative of the peak values. Such a reconstructed representation can be used for operations such as beamforming or other analysis. Use of the peak-representation approach herein can dramatically reduce a volume of data associated with acoustic echo signal acquisition, such as for full matrix capture (FMC) acquisition.

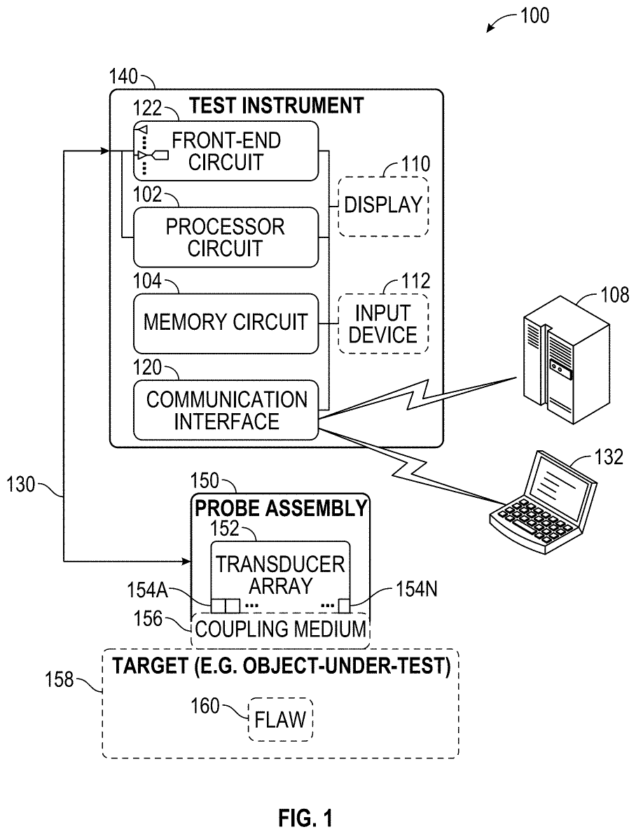

FIG. 1 illustrates generally an example comprising an acoustic inspection system 100, such as can be used to perform at least a portion one or more techniques as shown and described herein. The inspection system 100 can include a test instrument 140, such as a hand-held or portable assembly. The test instrument 140 can be electrically coupled to a probe assembly, such as using a multi-conductor interconnect 130. The probe assembly 150 can include one or more electroacoustic transducers, such as a transducer array 152 including respective transducers 154A through 154N. The transducers array can follow a linear or curved contour or can include an array of elements extending in two axes, such as providing a matrix of transducer elements. The elements need not be square in footprint or arranged along a straight-line axis. Element size and pitch can be varied according to the inspection application.

A modular probe assembly 150 configuration can be used, such as to allow a test instrument 140 to be used with various different probe assemblies 150. Generally, the transducer array 152 includes piezoelectric transducers, such as can be acoustically coupled to a target 158 (e.g., a test specimen or “object-under-test”) through a coupling medium 156. The coupling medium can include a fluid or gel or a solid membrane (e.g., an elastomer or other polymer material), or a combination of fluid, gel, or solid structures. For example, an acoustic transducer assembly can include a transducer array coupled to a wedge structure comprising a rigid thermoset polymer having known acoustic propagation characteristics (for example, Rexolite® available from C-Lec Plastics Inc.), and water can be injected between the wedge and the structure under test as a coupling medium 156 during testing, or testing can be conducted with an interface between the probe assembly 150 and the target 158 otherwise immersed in a coupling medium.

The test instrument 140 can include digital and analog circuitry, such as a front-end circuit 122 including one or more transmit signal chains, receive signal chains, or switching circuitry (e.g., transmit/receive switching circuitry). The transmit signal chain can include amplifier and filter circuitry, such as to provide transmit pulses for delivery through an interconnect 130 to a probe assembly 150 for insonification of the target 158, such as to image or otherwise detect a flaw 160 on or within the target 158 structure by receiving scattered or reflected acoustic energy elicited in response to the insonification.

While FIG. 1 shows a single probe assembly 150 and a single transducer array 152, other configurations can be used, such as multiple probe assemblies connected to a single test instrument 140, or multiple transducer arrays 152 used with a single or multiple probe assemblies 150 for pitch/catch inspection modes. Similarly, a test protocol can be performed using coordination between multiple test instruments 140, such as in response to an overall test scheme established from a master test instrument 140 or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples.

The receive signal chain of the front-end circuit 122 can include one or more filters or amplifier circuits, along with an analog-to-digital conversion facility, such as to digitize echo signals received using the probe assembly 150. Digitization can be performed coherently, such as to provide multiple channels of digitized data aligned or referenced to each other in time or phase. The front-end circuit can be coupled to and controlled by one or more processor circuits, such as a processor circuit 102 included as a portion of the test instrument 140. The processor circuit can be coupled to a memory circuit, such as to execute instructions that cause the test instrument 140 to perform one or more of acoustic transmission, acoustic acquisition, processing, or storage of data relating to an acoustic inspection, or to otherwise perform techniques as shown and described herein. The test instrument 140 can be communicatively coupled to other portions of the system 100, such as using a wired or wireless communication interface 120.

For example, performance of one or more techniques as shown and described herein can be accomplished on-board the test instrument 140 or using other processing or storage facilities such as using a compute facility 108 or a general-purpose computing device such as a laptop 132, tablet, smart-phone, desktop computer, or the like. For example, processing tasks that would be undesirably slow if performed on-board the test instrument 140 or beyond the capabilities of the test instrument 140 can be performed remotely (e.g., on a separate system), such as in response to a request from the test instrument 140. Similarly, storage of imaging data or intermediate data such as A-scan matrices of time-series data or other representations of such data, for example, can be accomplished using remote facilities communicatively coupled to the test instrument 140. The test instrument can include a display 110, such as for presentation of configuration information or results, and an input device 112 such as including one or more of a keyboard, trackball, function keys or soft keys, mouse-interface, touch-screen, stylus, or the like, for receiving operator commands, configuration information, or responses to queries.

The present inventors have recognized, among other things, that an amount of data associated with acoustic inspection acquisition can pose a challenge because storage for such data can be costly and difficult to manage. Another challenge can be that a data transfer rate between the probe, acquisition support circuitry, and analysis facilities, is generally limited, potentially reducing scan productivity. The techniques herein can be used to reduce a volume of a data set associated with acoustic inspection, facilitating archival or remote analysis. The techniques herein are applicable, for example, to full-matrix capture (FMC), where elementary (e.g., element-by-element or aperture-by-aperture) acoustic data is acquired and can be used to produce virtually any acoustic focusing configuration through further processing.

In generally-available non-destructive test (NDT) instruments, FMC data is used to compute an acoustic image contemporaneously and then such contemporaneously generated imaging may not be saved, nor is the underlying elementary acoustic data. In the present subject matter, data can be saved in compressed form for use in reconstructing a representation of the originally acquired acoustic echo signals (e.g., elementary A-scan representations) using a filter (e.g., a digital filter). Examples of techniques (such as software or firmware implemented methods), are discussed below. As an illustrative example, some or all computation (e.g., compression or decompression) could be performed using a digital signal processor (DSP) or field-programmable gate array (FPGA) such as during acquisition, or thereafter.

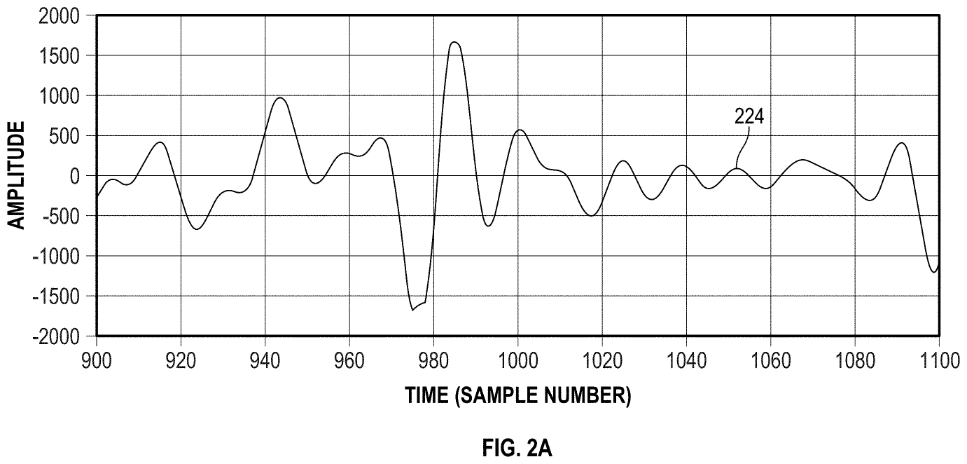

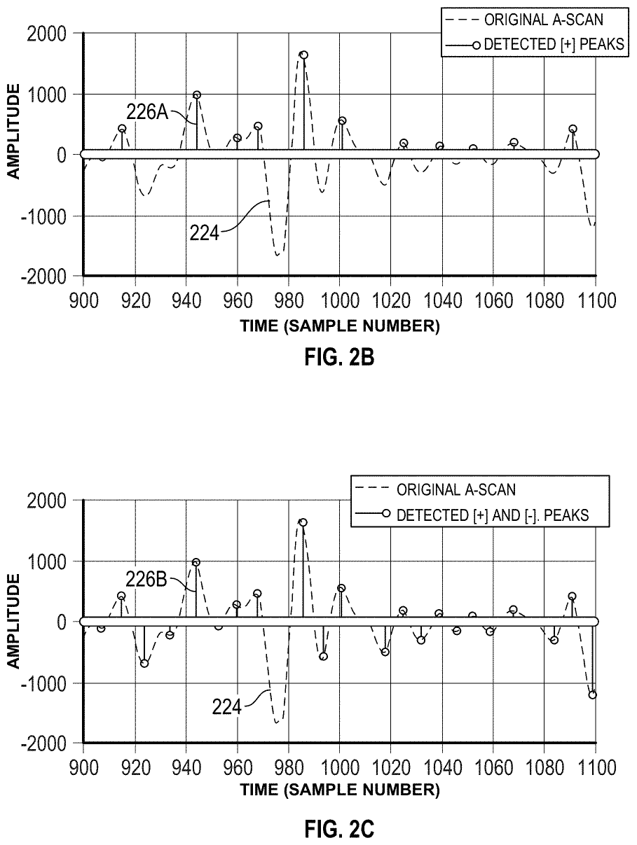

FIG. 2A shows an illustrative example of an acquired acoustic echo signal 224 (e.g., representative of an acquired A-scan echo signal). The acquired acoustic echo signal 224 can be one signal amongst many such acquired signals related to an acoustic inspection operation. Such signals can be analyzed, such as used for PAUT or TFM beamforming and related imaging. Generally, due to a volume of acoustic echo signal associated with an acquisition operation, imaging performed using PAUT or TFM may not include saving all the underlying acoustic echo data (or even any of the data). When such data is saved for further analysis or archival purposes, it can occupy a significant storage volume or consume significant resources in terms of network bandwidth. The present inventors have recognized, among other things, that compression of such acquired acoustic echo data facilitates storage, on-line or off-line analysis, and archival, providing enhanced traceability and analysis support.

Generally, a peak encoding technique can be used to perform encoding for storage or transmission (such as to provide a “compressed” representation of the acoustic echo signal 224). For example, FIG. 2B shows an illustrative example of identification of positive-going peak locations 226A in the acquired acoustic echo signal 224 of FIG. 2A. FIG. 2C shows yet another illustrative example of identification of positive-going peak locations and negative-going peak locations 226B in the acquired acoustic echo signal 224 of FIG. 2A. Generally, as illustrated in FIG. 2B and FIG. 2C, detection of peaks can include identifying either positive and negative-going ([+] and [−]) or only positive or negative-going peaks ([+] or [−]). Detecting only ([+] or [−]) peaks as shown illustratively in FIG. 2B allows for a greater degree of compression, but with a potentially greater degree of mismatch between the originally acquired acoustic echo signal 224 and a reconstructed representation. By contrast, detecting both ([+] and [−]) peaks, as shown in FIG. 2C, allows for better signal reconstruction (e.g., interpolation), but with a lesser degree of data compression.

Encoding of the detected peaks can include storage in a form where the digital representations of peak locations in acquired acoustic echo data encode a temporal location of respective peaks and amplitudes of respective peaks. For example, temporal locations of the respective peaks can be encoded as a temporal offset from an adjacent peak location (rather than in terms of some absolute time reference). The temporal offset can be in terms of a count of samples.

As an illustration, a series of peaks can be encoded, streamed, or stored in a form as follows: [Peak Time Step][Peak Amp][Peak Time Step][Peak Amp], and so on. As a numerical example, a stream of encoded data can be provided as follows: [Peak Step][Peak Amp][Peak Time Step][Peak Amp] . . . =[16][241][16][45][26][220] . . . , and a count of bits for encoding ‘Peak Step’=ceil(log 2(max([Peak Time Step]))). The respective [Peak Time Step] values can correspond to a count of samples between a prior peak and a present peak or another relative indication of temporal position. Such an approach allows temporal positions of peaks to be saved using a reduced count of bits (between 3 and 6 bits, as an illustrative example) versus a timestamp. Generally, a data structure and related memory allocation (e.g., bit depth) for time step encoding may depend on a center acoustic frequency of a probe used (e.g., given a specified sampling rate and A-Scan record length (e.g., echo signal time-series duration). Generally, a lower-bandwidth probe or a probe operating at a lower center frequency produces less high-frequency information (and corresponding peaks) than a higher-bandwidth probe or a probe otherwise operating a higher center frequency. The amplitude can be encoded in 12 bits, as an illustrative example.

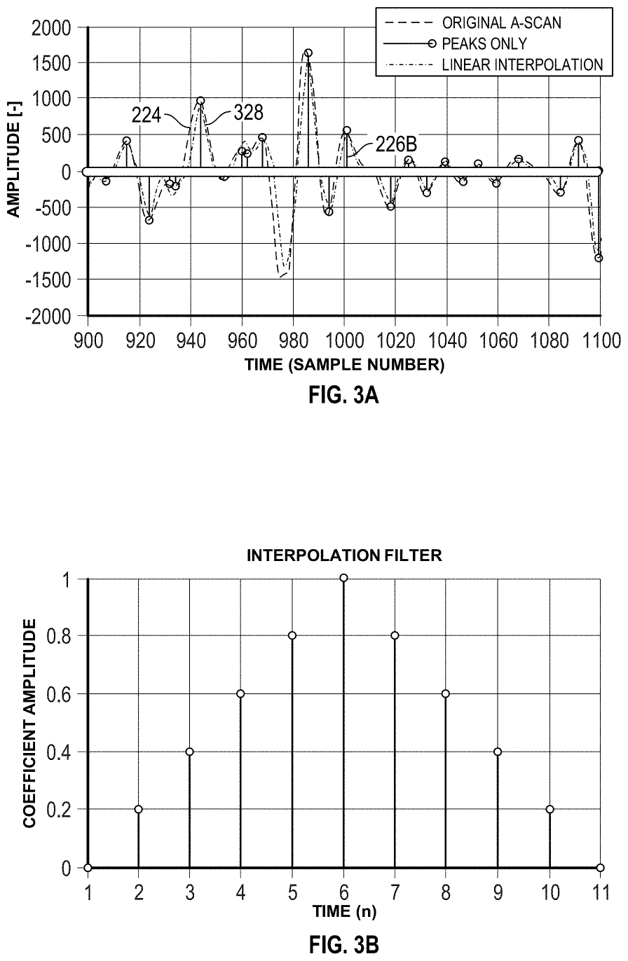

FIG. 3A shows a comparison between the originally acquired acoustic echo signal 224 (e.g., the A-scan) of FIG. 2A, identified positive-going peak locations and negative-going peak locations 226B, and a reconstructed time-series representation 328 generated using a linear interpolation filter. Reconstruction (e.g., interpolation) of a representation of the original acoustic echo signal 224 can include an up-sampling and zero-padding process to produce a data set as shown corresponding to the identified positive-going peak locations and negative-going peak locations 226B. Such a data set can be representative of a compressed signal comprising delayed Dirac delta functions having respective amplitudes corresponding to respective peak amplitude values, and such representations can then be convolved with a finite impulse response (FIR) filter. For example, FIG. 3B shows the filter coefficient amplitudes versus filter tap (corresponding to a time delay of “n” samples) for the linear interpolation filter used to generate the reconstructed time-series representation 328 shown in FIG. 3A. When operating using both [+] and [−] peaks, a linear FIR filter such as having a gaussian profile can be used, and such a technique can be referred to herein as “Method A.”

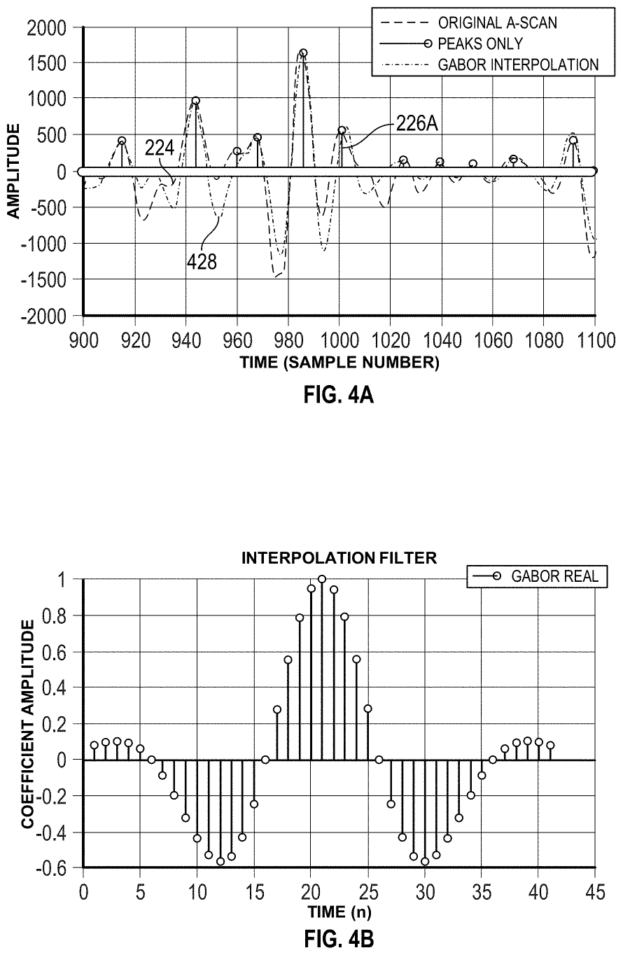

A greater degree of data reduction can be achieved by encoding only positive-going or negative-going peaks (rather than encoding both positive-going and negative-going peaks). For example, FIG. 4A shows a comparison between the originally acquired acoustic echo signal 224 (e.g., the A-scan) of FIG. 2A, identified positive-going peak locations 226A, and a reconstructed time-series representation 428 generated using a wavelet (e.g., Gabor) filter. FIG. 4B shows the filter coefficient amplitudes versus filter tap (corresponding to a time delay of “n” samples) for the wavelet interpolation filter used to generate the reconstruction shown in FIG. 4A. The interpolation approach shown in FIG. 4A and FIG. 4B can be referred to as “Method B.” In Method B, when encoding only the positive-going peaks, a wavelet FIR interpolation filter profile can be used to reconstruct (e.g., via interpolation) the original signal, with an impulse response defining the wavelet profile resembling a transmitted pulse profile, such as having a center frequency and envelope similar to the transmitted pulse profile.

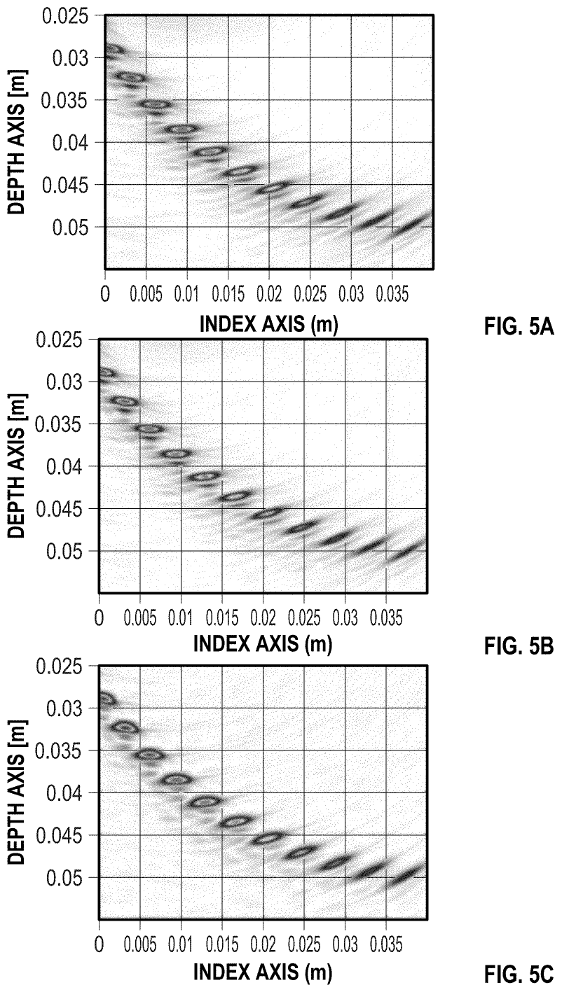

As an illustrative example, using TFM beamforming, a group of reconstructed A-Scans can be assembled, such as to mimic an original FMC acquisition, and the reconstructed FMC A-scan representations can be used to generate an image. FIG. 5A shows an illustrative example of imaging generated using a Total Focusing Method (TFM) summation, performed on Full Matrix Capture (FMC) data comprising a matrix of A-scan time-series representations that have not been compressed or reconstructed, where elements in the FMC matrix define respective transmit-receive aperture pairs used for acquisition. FIG. 5B shows an illustrative example of imaging generated using a Total Focusing Method (TFM) summation for beamforming, performed on Full Matrix Capture (FMC) data comprising a matrix of reconstructed time-series representations generated using a linear interpolation filter (e.g., “Method A”), similar to the example of FIG. 3B, where the reconstruction is performed by applying the interpolation filter to data indicative of positive-going and negative-going peak locations in each respective time series. FIG. 5C shows an illustrative example of imaging generated using a Total Focusing Method (TFM) summation for beamforming, performed on Full Matrix Capture (FMC) data comprising a matrix of reconstructed time-series representations generated using a wavelet-based interpolation filter (e.g., “Method B”), similar to the example of FIG. 4B, where the reconstruction is performed by applying the interpolation filter to data indicative of positive-going peak locations in each respective time series.

As mentioned above, Method A and Method B can provide different degrees of data reduction versus uncompressed echo signal storage. The tables below present illustrative examples of compression ratios for different probe central frequencies. For such illustrations, a probe having 64 elements is used and A-scans records having a duration of 8000 samples are used. Sampling frequency, Fs=100 MHz. For Method A, an amplitude of peaks is encoded using 12 signed bits (e.g., a scale from (−2048) to (2047)). For Method B, an amplitude of the peaks is coded using 11 unsigned bits (e.g., a scale 0-2047). A duration or “period” between adjacent peaks is estimated for Method A to be Fs/(2*Fc), and for Method B, Fs/Fc, where Fs=Sampling Frequency, and Fc=Probe Central Frequency.

Compressed FMC record size values can be established using the following expressions. Method A: (64*64)*ceil(8000/Peaks Period)*(12+ceil(log 2(Peaks Period)))/(8000000)=X_{A} MB; and Method B: (64*64)*ceil(8000/Peaks Period)*(10+ceil(log 2(Peaks Period)))/(8000000)=X_{B} MB. A division by 8000000 is used to convert results from bits to megabytes (MB), where 1 byte=8 bits.

TABLE 1
Results using Method A

| | | | Average | | |
|---|---|---|---|---|---|
| Probe | | | Peaks | Compressed | Compression |
| Frequency | | FMC size | Time Step | FMC size | Ratio |
| 1.5 | MHz | 49.152 MB | 33 | 2.2 MB | 22 |
| 2.25 | MHz | 49.152 MB | 22 | 3.1 MB | 15.7 |
| 5 | MHz | 49.152 MB | 10 | 6.6 MB | 7.5 |
| 10 | MHz | 49.152 MB | 5 | 12.3 MB | 4 |

TABLE 2
Results using Method B

| | | | Average | | |
|---|---|---|---|---|---|
| Probe | | | Peaks | Compressed | Compression |
| Frequency | | FMC size | Time Step | FMC size | Ratio |
| 1.5 | MHz | 49.152 MB | 66 | 1.2 MB | 42.1 |
| 2.25 | MHz | 49.152 MB | 44 | 1.7 MB | 29.6 |
| 5 | MHz | 49.152 MB | 20 | 3.5 MB | 14.1 |
| 10 | MHz | 49.152 MB | 10 | 6.6 MB | 7.5 |

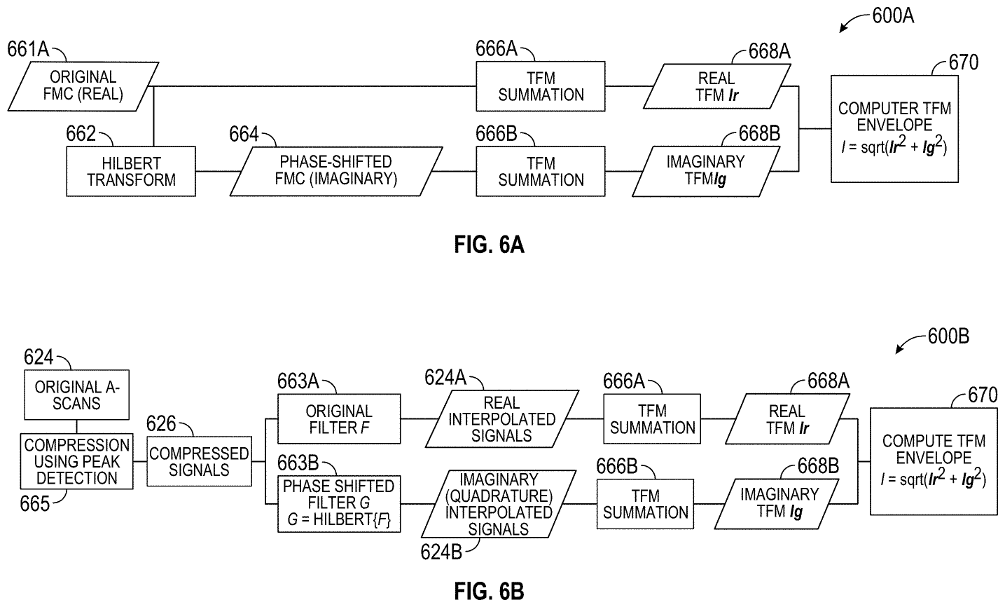

Generally, when computing a TFM image, an envelope signal is used and phase information is discarded. Use of an envelope is not intended in a restrictive sense, and in other approaches, phase data can be used for TFM image reconstruction. In an example where envelope data is to be used, an A-scan quadrature signal (phase-shifted A-scan) can be obtained or generated in order to compute a real-component TFM summation (using original A-scans) and an imaginary-component (e.g., quadrature) TFM summation (e.g., using the quadrature A-scans), and then the real-valued and imaginary-valued representations can be used to obtain a TFM envelope for each grid location in the image. This process is shown generally in the flow of FIG. 6A, which shows a technique 600A, such as a machine-implemented method, that can be used for performing beamforming and related imaging using a Total Focusing Method (TFM), including generation of an analytic signal representation. At 661A, real-valued FMC data (e.g., a matrix of A-scan representations representative of respective transmit-receive aperture pairs) can be obtained. At 666A, a TFM summation can be performed, generally where the A-scan time-series data are delayed or phase-shifted based on a time-of-flight to a grid location of interest, and then coherently summed. In parallel, at 662, a Hilbert transform or other operation can be used to establish a phase-shifted FMC data set 664, which can then be coherently summed at 666B in a manner similar to the summation at 666A. Resulting real-valued TFM summation results Ir 668A and imaginary-valued TFM summation results Ig 668B can be processed to provide, for example, an envelope determination 670 for each grid location of interest, to provide an image or other visual representation of an inspection result for display or storage.

The present inventors have recognized that techniques (e.g., interpolation filtering) for reconstruction as shown and described herein can be combined with the Hilbert transform approach to contemporaneously perform interpolation and generation of real and quadrature representations of the A-scan data for TFM beamforming and associated imaging. For example, FIG. 6B shows a technique 600B, such as a machine-implemented method, that can be used for performing beamforming and related imaging using a Total Focusing Method (TFM), where related interpolation filters can be used for signal reconstruction and generation of an analytic signal representation contemporaneously. At 624, A-scan data can be obtained, such as similar to the real-valued FMC data of FIG. 6A at 661A. At 665, peak identification and encoding can be performed, such as discussed above (e.g., using Method A or Method B). At 626, compressed signals can be stored or transmitted, such as to a remotely-located processing unit separate from an acquisition unit used to acquire the original A-scans at 624. At 663A, an interpolation filter, “F,” such as the filter of FIG. 3B or FIG. 4B can be applied (e.g., using convolution) to reconstruct a real-valued representation 624A of the original A-scan data.

In parallel, at 663B a phase-shifted interpolation filter, “G,” can be applied (e.g., also using convolution) to reconstruct an imaginary-valued representation 624B, so that the combination of the real-valued representation 624A and the imaginary-valued representation 624B form an analytic representation of the originally-acquired A-scan data. In this approach, the Hilbert transform is merged with the reconstruction filter, “G,” at 663B to generate the reconstructed A-scan representations. For example, two different FIR filters can be used to obtain the real component signal and the imaginary component (e.g., quadrature signal). The original interpolation filter can be phased-shifted by 90° (corresponding to an output of a Hilbert transform), to provide a filter for use in generating the quadrature signal. The remainder of the technique 600B is similar to the technique 600A, with TFM summation being performed at 666A and 666B, to provide the real-valued TFM summation results Ir 668A and imaginary-valued TFM summation results Ig 668B, with an envelope determination 670 being made for each grid location of interest, to provide an image or other visual representation of an inspection result for display or storage.

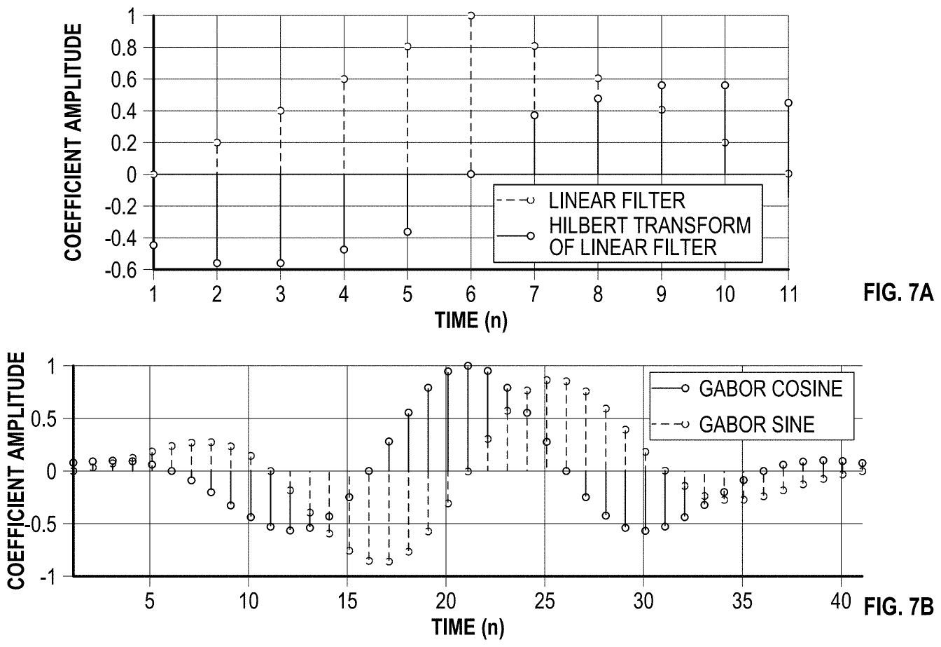

FIG. 7A shows the filter coefficient amplitudes versus filter tap (corresponding to a time delay of “n” samples) for two related linear interpolation filters that can be used in relation to the technique of FIG. 6B to perform reconstruction contemporaneously with generation of an analytic signal representation for beamforming and imaging. FIG. 7B shows the filter coefficient amplitudes versus filter tap (corresponding to a time delay of “n” samples) for two related wavelet interpolation filters that can be used in relation to the technique of FIG. 6B to perform reconstruction contemporaneously with generation of an analytic signal representation for beamforming and imaging.

In the example of a Gabor wavelet filter profile, as shown illustratively in FIG. 7B, the phase-shifted counterparts can be generated analytically, with t representing time, ω₀ representing an undamped oscillation frequency, and a representing a damping parameter defining an exponential envelope shape:

$$Gabor Cosine : {e}^{- \frac{{t}^{2}}{2 {σ}^{2}}} cos ( {ω}_{0} t ) \qquad EQN . 1$$

$$Gabor Sine : {e}^{- \frac{{t}^{2}}{2 {σ}^{2}}} sin ( {ω}_{0} t ) \qquad EQN . 2$$

In the illustrative examples of imaging shown in FIG. 5B and FIG. 5C, and the corresponding interpolation filter coefficients shown in FIG. 3B and FIG. 4B, the reconstruction filters (linear and Gabor) were not particularly optimized for the anticipated A-Scan signal. A filter length (e.g., count of taps) of the linear filter was chosen to be about the length of the peak-to-peak period, while the parameters of the Gabor filter were obtained using information about the inspection setup (e.g., probe and wedge geometry, for example). Other approaches can be used to establish filter configuration and coefficients. For example, it is possible to establish the filter parameters using the experimentally-obtained or modeled A-scan information. For example, the Gabor filter parameters can be established using the following expressions:

$$F = {e}^{- \frac{{t}^{2}}{{σ}^{2}}} cos ( {ω}_{0} t + ϕ ) \qquad EQN . 3$$

$$σ = \frac{\sqrt{8 ln 2}}{{ω}_{0} {B}_{w}} \qquad EQN . 4$$

Accordingly, the filter parameters can be established as a function of the probe central frequency ω₀, the probe bandwidth B_{w}, and a phase parameter ϕ, as an illustrative example. For the examples here, nominal parameters for probe configuration are used (ω₀=2π*(5,000,000); B_{w}=0.6; ϕ=0). However, these parameters could be selected in a manner to reduce the error between the original A-scan A, and the reconstructed A-scan, (Ac*F), using a minimization or other optimization technique. An illustrative example of a form of an optimization function is shown below:

$$( {ω}_{0} , {B}_{w} , ϕ ) = {min}_{{ω}_{0} , {B}_{w} , ϕ} ( A - ( {A}_{c} * F ( {ω}_{0} , {B}_{w} , ϕ ) ) ) \qquad EQN . 5$$

An optimization could be executed across an entire acquisition, such as across an entire FMC data set (or multiple data sets), or for individual A-scans. For the latter, an optimized FIR filter coefficient set could be encoded at the end of the coded A-scan record (or elsewhere in a record associated with the compressed A-scan representation). The Gabor filter profile is merely illustrative of one wavelet filter example. Other types of wavelet kernels or filter configurations can be used (e.g. Morlet, Mexican Hat, or the like). Generally, an impulse response of the filter is selected to correspond to the transmitted probe pulse or corresponding echo (e.g., a to a pulse morphology). The examples herein refer to TFM summation being performed using both amplitude and peak temporal location data. In another example, a temporal position of the [+] or [−] peak locations (e.g., without taking into account the amplitude information) can be used independently to perform a TFM summation. For example, peak locations have the same periodic properties as edges in the A-Scan signal phase. Accordingly, a binary phase TFM summation can be performed using data indicative of the peak temporal positions, without requiring amplitude values, in a manner similar to a phase-based approach for performing TFM summation and related imaging.

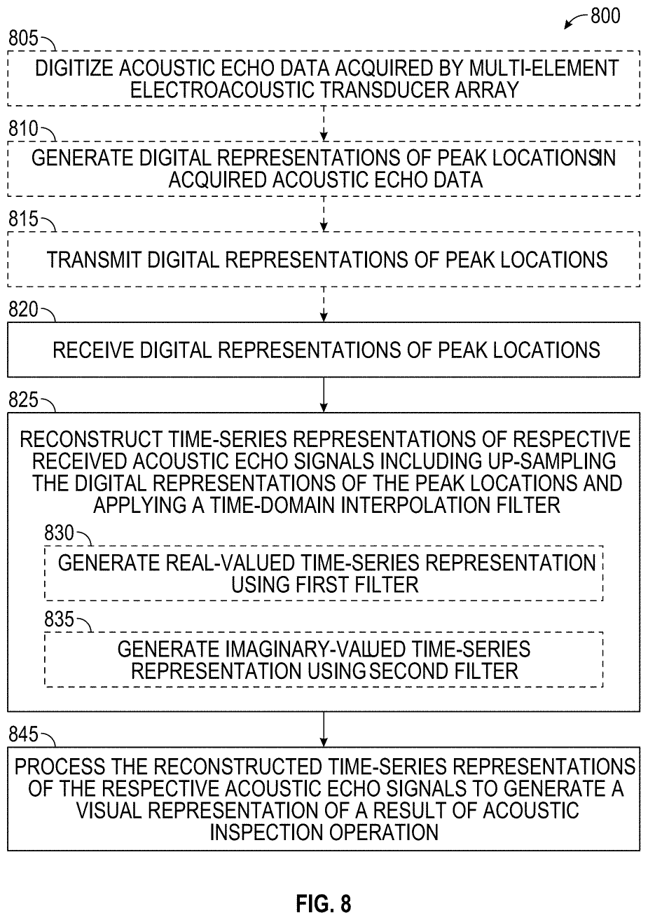

FIG. 8 illustrates generally a technique 800, such as a method, that can be used for performing processing of time-series representations, such as to perform one or more of compression or decompression of digital representations of acoustic imaging data. For example, at 820, digital representations of peak locations in acquired acoustic echo signal data can be received, such as from a wired or wireless network or storage device. At 825, time-series representations of respective received acoustic echo signals can be reconstructed, such as including up-sampling the digital representations of peak locations and applying a time-domain interpolation filter. At 830, a real-valued time-series representation can be generated, and optionally, at 835, an imaginary-valued time-series representation can be generated, such as using a second filter having coefficients that represent a phase-shifted version of the first filter or a Hilbert transform thereof. At 845, the reconstructed time-series representations can be processed, such as to generate a visual representation of an acoustic inspection operation. As discussed above, such processing can include TFM beamforming accomplished by coherent summation of respective reconstructed acoustic echo signals. TFM beamforming is merely an example, and the techniques described herein are applicable to other beamforming and related imaging modalities, such as imaging techniques that can be performed using acquired FMC data, more generally. The operations at 820, 825, and 845 can be performed using a compute facility that is separate from the apparatus used for actual acoustic acquisition. For example, at 805, acoustic echo data can be acquired and digitized, such as acquired by a multi-element electroacoustic transducer array forming a portion of a probe assembly. At 810, digital representations of the peak locations can be generated, such as corresponding to peak detection and encoding as discussed above. At 815, the digital representations of the peak locations can be transmitted from an acquisition unit to a separate processing unit. In this manner, acquisition and subsequent imaging operations need not be performed using a single compute facility or in a single location.

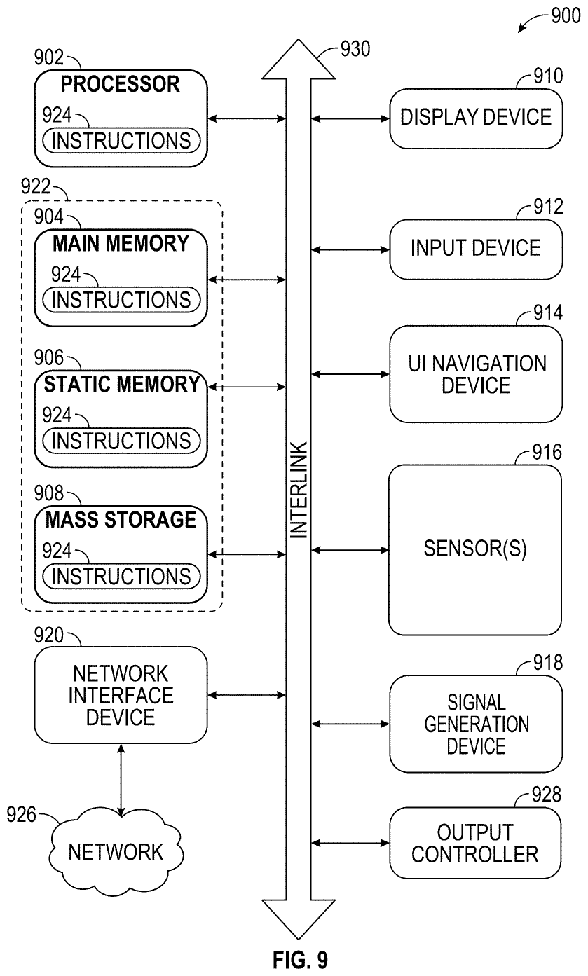

FIG. 9 illustrates a block diagram of an example comprising a machine 900 upon which any one or more of the techniques (e.g., methodologies) discussed herein may be performed. Machine 900 (e.g., computer system) may include a hardware processor 902 (e.g., a central processing unit (CPU), a graphics processing unit (GPU), a hardware processor core, or any combination thereof), a main memory 904 and a static memory 906, connected via an interconnect 908 (e.g., link or bus), as some or all of these components may constitute hardware for systems or related implementations discussed above.

Specific examples of main memory 604 include Random Access Memory (RAM), and semiconductor memory devices, which may include storage locations in semiconductors such as registers. Specific examples of static memory 906 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 900 may further include a display device 910, an input device 912 (e.g., a keyboard), and a user interface (UI) navigation device 914 (e.g., a mouse). In an example, the display device 910, input device 912 and UI navigation device 914 may be a touch-screen display. The machine 900 may include a mass storage device 916 (e.g., drive unit), a signal generation device 918 (e.g., a speaker), a network interface device 920, and one or more sensors 930, such as a global positioning system (GPS) sensor, compass, accelerometer, or some other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the mass storage device 916 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine readable medium 922 is illustrated as a single medium, the term “machine readable medium” may include a single medium or multiple media (e.g., a centralized or distributed database, or associated caches and servers) configured to store the one or more instructions 924.

An apparatus of the machine 900 includes one or more of a hardware processor 902 (e.g., a central processing unit (CPU), a graphics processing unit (GPU), a hardware processor core, or any combination thereof), a main memory 904 and a static memory 906, sensors 930, network interface device 920, antennas 932, a display device 910, an input device 912, a UI navigation device 914, a mass storage device 916, instructions 924, a signal generation device 918, or an output controller 928. The apparatus may be configured to perform one or more of the methods or operations disclosed herein.

The term “machine readable medium” includes, for example, any medium that is capable of storing, encoding, or carrying instructions for execution by the machine 900 and that cause the machine 900 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 924 may be transmitted or received, for example, over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 920 includes one or more physical jacks (e.g., Ethernet, coaxial, or other interconnection) or one or more antennas to access the communications network 926. In an example, the network interface device 920 includes one or more antennas 932 to wirelessly communicate using at least one of single-input multiple-output (SIMO), multiple-input multiple-output (MIMO), or multiple-input single-output (MISO) techniques. In some examples, the network interface device 920 wirelessly communicates using Multiple User MIMO techniques. The term “transmission medium” shall be taken to include any intangible medium that is capable of storing, encoding or carrying instructions for execution by the machine 900, and includes digital or analog communications signals or other intangible medium to facilitate communication of such software.

### Various Notes

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A machine-implemented method for processing compressed acoustic inspection data, the machine-implemented method comprising:
receiving digital representations of peak locations in acquired acoustic echo data corresponding to respective received acoustic echo signals, the respective received acoustic echo signals corresponding to transducer apertures of a multi-element electroacoustic transducer array used for an acoustic inspection operation;
reconstructing time-series representations of respective received acoustic echo signals including up-sampling the digital representations of the peak locations and applying a time-domain interpolation filter; and
processing the time-series representations of the respective received acoustic echo signals to generate a visual representation of a result of the acoustic inspection operation;
wherein the digital representations of the peak locations comprise a lesser volume of data than the reconstructed time-series representations.

2. The machine-implemented method of claim 1, wherein the digital representations of the peak locations comprise digital representations of positive-going peaks relative to a reference level.

3. The machine-implemented method of claim 1, wherein the time-domain interpolation filter comprises a finite-impulse-response (FIR) discrete time filter.

4. The machine-implemented method of claim 1, wherein the digital representations of the peak locations comprise digital representations of positive-going peaks and negative-going peaks relative to a reference level.

5. The machine-implemented method of claim 1, wherein the time-domain interpolation filter comprises a discrete time wavelet filter.

6. The machine-implemented method of claim 5, wherein the discrete time wavelet filter comprises a Gabor wavelet filter.

7. The machine-implemented method of claim 1, wherein applying the time-domain interpolation filter comprises applying two discrete time digital filters comprising a first filter comprising first filter coefficients that generate a real-valued time-series representation, and a second filter comprising different second filter coefficients that generate an imaginary-valued time-series representation in phase quadrature with the real-valued time-series representation.

8. The machine-implemented method of claim 7, wherein a combination of the real-valued time-series representation and the imaginary-valued time-series representation comprise an analytic signal representation.

9. The machine-implemented method of claim 1, wherein the digital representations of peak locations in acquired acoustic echo data encode a temporal location of respective peaks and amplitudes of respective peaks.

10. The machine-implemented method of claim 9, wherein temporal locations of the respective peaks are encoded as a temporal offset from an adjacent peak location.

11. The machine-implemented method of claim 10, wherein the temporal offset comprises a count of samples.

12. The machine-implemented method of claim 1, wherein the time-series representations of respective received acoustic echo signals comprise A-scan representations.

13. The machine-implemented method of claim 1, wherein processing the time-series representations of the respective received acoustic echo signals to generate the visual representation of the result of the acoustic inspection operation comprises performing a Total Focusing Method (TFM) using a matrix of A-scan representations corresponding to the time-series representations, where elements in the matrix correspond to specified transmit and receive aperture pairs.

14. The machine-implemented method of claim 1, wherein the up-sampling the digital representations of the peak locations includes establishing a time-series having peak locations corresponding to the digital representations and padding the time-series between the peak locations according to specified sample interval.

15. A system for processing compressed acoustic inspection data, the system comprising:
a first processing facility comprising:
at least one first processor circuit; and
at least one first memory circuit; and
a first communication circuit communicatively coupled with the first processing facility;
wherein the at least one first memory circuit comprises instructions that, when executed by the at least one first processor circuit, cause the system to:
receive, using the first communication circuit, digital representations of peak locations in acquired acoustic echo data corresponding to respective received acoustic echo signals, the respective received acoustic echo signals corresponding to transducer apertures of a multi-element electroacoustic transducer array used for acoustic inspection operation;
reconstruct time-series representations of respective received acoustic echo signals including up-sampling the digital representations of the peak locations and applying a time-domain interpolation filter; and
process the time-series representations of the respective received acoustic echo signals to generate a visual representation of a result of the acoustic inspection operation;
wherein the digital representations of the peak locations comprise a lesser volume of data than the reconstructed time-series representations.

16. The system of claim 15, further comprising:
a second processing facility comprising:
at least one second processor circuit; and
at least one second memory circuit; and
a second communication circuit communicatively coupled with the second processing facility and communicatively coupled with first communication circuit;
wherein the at least one second memory circuit comprises instructions that, when executed by the at least one second processor circuit, cause the system to:
digitize acoustic echo data acquired by the multi-element electroacoustic transducer array using an analog front-end circuit coupled with the multi-element electroacoustic transducer array;
generate digital representations of peak locations in acquired acoustic echo data corresponding to respective received acoustic echo signals; and
transmit, using the second communication circuit, the digital representations of peak locations to the first communication circuit.

17. The system of claim 15, wherein the digital representations of peak locations in acquired acoustic echo data encode a temporal location of respective peaks and amplitudes of respective peaks.

18. The system of claim 15, wherein the time-series representations of respective received acoustic echo signals comprise A-scan representations.

19. The system of claim 15, wherein the instructions to process the time-series representations of the respective received acoustic echo signals to generate the visual representation of the result of the acoustic inspection operation comprise instructions to perform a Total Focusing Method (TFM) using a matrix of A-scan representations corresponding to the time-series representations, where elements in the matrix correspond to specified transmit and receive aperture pairs.

20. A system for processing compressed acoustic inspection data, the system comprising:
a means for digitizing acoustic echo data acquired by a multi-element electroacoustic transducer array;
a means for generating digital representations of peak locations in acquired acoustic echo data corresponding to respective received acoustic echo signals, the respective received acoustic echo signals corresponding to transducer apertures of a multi-element electroacoustic transducer array used for an acoustic inspection operation;
a means for reconstructing time-series representations of respective received acoustic echo signals including up-sampling the digital representations of the peak locations and applying a time-domain interpolation filter; and
a means for processing the time-series representations of the respective received acoustic echo signals to generate a visual representation of a result of the acoustic inspection operation;
wherein the digital representations of the peak locations comprise a lesser volume of data than the reconstructed time-series representations.
